(19) United States
(12) Patent Application Publication
(10) Pub. No.: US 2015/0097945 A1
(43) Pub. Date: Apr. 9, 2015

(54) DEVICE AND METHOD FOR HANDLING MONEY TRANSACTIONS

(71) Applicants: Roland Mührenberg, Lubeck (DE); Jurgen Bornschein, Tactenbuttel (DE); Marco Zander, Kiel (DE); Marc Rinderspacher, Hamburg (DE)

(72) Inventors: Roland Mührenberg, Lubeck (DE); Jurgen Bornschein, Tactenbuttel (DE); Marco Zander, Kiel (DE); Marc Rinderspacher, Hamburg (DE)

(73) Assignee: Novoomatic AG, Gumpoldskirchen (AT)

(21) Appl. No.: 13/381,970

(22) PCT Filed: Jun. 25, 2010
(86) PCT No.: PCT/IB10/01552

§ 371 Date: Jun. 16, 2014

(30) Foreign Application Priority Data
Jul. 9, 2009 (DE) 202009009470.7

(51) Int. Cl. G06F 1/16; G07F 19/00; G06Q 20/10

(52) U.S. Cl. CPC G06F 1/1601; G06Q 20/1085; G07F 19/205; G06F 1/1605; G06F 2200/1637
USPC 348/135

(57) ABSTRACT

Device (10) for handling money transactions, comprising a housing (11) and a screen (12; 100) enclosed in the housing (11), wherein the screen (12; 100) is arranged to be rotatable or tiltable about at least one axis (3, 4, 5; 6, 7, 8; 20, 21, 22; 23, 24, 25; 26, 27) such that a change to the tilt of the screen (12; 100) can occur manually or automatically, where the axis (3, 4, 5; 6, 7, 8; 20, 21, 22; 23, 24, 25; 26, 27) lies essentially flush with the screen's surface (1).

### CROSS-REFERENCE TO RELATED APPLICATIONS

This application claims priority under 35 U.S.C. 119(a) and 365(b) to PCT/IB20 10/001552, having an international filing date of Jun. 25, 2010.

### FIELD OF THE INVENTION

The invention involves a device, for handling of money transactions, as with pay machines, cash dispensers, money changers, currency changers, slot machines, or the like, by means of which money transactions can be settled.

### BACKGROUND AND SUMMARY OF THE INVENTION

Pay machines, supermarket pay machines, ATMs, cash dispensers, money changers, currency changers, vending machines, slot machines, and machines for cashless or cash-bound payment or exchange transactions, check-in or check-out terminals, or the like are examples of devices for handling money transactions.

Adjustable screens, in which a computer's or notebook's screen can be manually adjusted to enable an optimum viewing angle for a user in one location, have become familiar in entertainment-electronics devices. Television sets for which motor-driven adjustment can be executed have also become familiar.

EP1016950A1 discloses an adjustable screen; in particular, it relates to adjusting a liquid crystal display (LCD) in relation to a screen support or a monitor base mount. Adjustment occurs with the aid of an electric motor that drives a worm wheel, which in turn is coupled with an arc-shaped tooth-hole gear mounted on the foot. Adjustment is possible in the form of a rocking motion.

In devices for handling money transactions, as with pay machines, cash dispensers, money changers, currency changers, slot machines, or the like, by means of which money transactions can be settled, the state of the art is either no screen—only a display, or only a rigid, built-in screen is provided. However, this incurs the disadvantage that the screen is not easily readable, depending on the viewer's height and the lighting situation. User-friendliness is thereby degraded and the acceptance of such devices impaired.

One goal of the present invention includes providing a device for handling money transactions, comprising a housing and a screen enclosed in the housing with which optimum use and viewability of the screen is enabled.

This is achieved by the features of claim 1, whereby a device for handling money transactions is provided with a housing and a screen enclosed in the housing, wherein the screen is arranged to rotate or tilt about at least one axis such that a change in the screen's tilt can be effected manually or automatically, and such that the axis lies essentially flush with the screen's surface. This enables the device's user to automatically or manually adjust the screen so that he can read the screen as well as possible, and any reflections can be reduced or prevented.

The degree of sunlight or other light source reflection makes it difficult to read information on a screen and is largely determined by the angle of the light source with the screen or monitor, and the angle of the viewer's eyes with the screen.

It is also advantageous if the screen can rotate or tilt relative to the housing about a horizontal axis and/or about a vertical axis, whereby the axis lies essentially flush with the screen's surface. This can advantageously lead to the screen being adjusted in such a way that undesired reflections can be avoided.

In one embodiment of the invention, the screen can be tilted about a horizontal axis relative to the housing, the axis being arranged in the screen's central area. It is advantageous in a further embodiment that the screen can be tilted about a horizontal axis relative to the housing, the axis being arranged in the screen's lower area. It is advantageous in another embodiment that the screen can be tilted about a horizontal axis relative to the housing, the axis being arranged in the screen's upper area.

It is advantageous in one embodiment that the screen is rotatable about a vertical axis relative to the housing, the axis being arranged in the screen's central area. It is advantageous in a further embodiment that the screen is rotatable about a vertical axis relative to the housing, the axis being arranged in the screen's lateral right area. It is advantageous in one embodiment that the screen is rotatable about a vertical axis relative to the housing, the axis being arranged in the screen's lateral left area.

This allows the choice of the axis to be adjusted to the device's requirements so that users of different heights can selectively adjust the screen to avoid the occurrence of reflections.

The positioning of a ball joint on the back of the screen for rotating and/or tilting the screen mounting on the housing is particularly advantageous.

According to the invention, screen adjustment occurs via the screen's automated operation through electromotive means. In this connection, it is particularly advantageous if the screen's electromotive operation is menu driven. In addition, a menu can be presented on the screen, a touch screen for instance, user operation of which controls the adjustment of screen orientation. Adjustment can also occur with an element capable of manual operation, such as a slider.

It is also advantageous if electromotive screen operation occurs via preset data or signals. Here, these data can be stored on a data carrier such as a memory chip so that the data are read out and the adjustment made automatically when the memory chip is inserted.

In another embodiment, it is convenient if the screen's electromotive operation occurs by voice control with speech recognition.

It is furthermore advantageous if a sensor that detects whether and how strong the screen's reflection is for the observer controls the screen's electromotive operation.

The above-mentioned aspects and other aspects of the invention will become apparent from the embodiments described below and are based on these illustrated embodiments.

### DESCRIPTION OF THE DRAWINGS

The invention is described in terms of various embodiments presented in the drawings, to which the invention is not limited, and wherein:

FIG. 1 is a schematic representation of a screen with the possible arrangement of rotational axes.

FIG. 2 is a schematic representation of a screen with the possible arrangement of rotational axes.

FIG. 3a is a front view of a device for settlement of money transactions.

FIG. 3b is a perspective view of the device of FIG. 3a with a folded in screen.

FIG. 4a is a front view of a device for settlement of money transactions.

FIG. 4b is a perspective view of the device of FIG. 4a with a folded out screen.

FIG. 5 is a schematic representation of a screen with possible arrangements of rotational axes.

FIG. 6 is a schematic representation of a screen with possible arrangements of rotational axes.

FIG. 7 is a schematic representation of the observer's viewing angle with the monitor.

FIG. 8 and FIG. 9 are schematic representations of the time-dependent influence of the sun's or light source's incidence and reflection angle in front of the screen.

FIG. 10 is a schematic representation of a light sensor on the screen.

FIG. 11 is a schematic representation of various functional components of the device according to the invention.

FIG. 12 is a flow chart depicting a device calibration workflow.

FIG. 13 is a flow chart showing a change-of-screen-inclination workflow.

### DETAILED DESCRIPTION

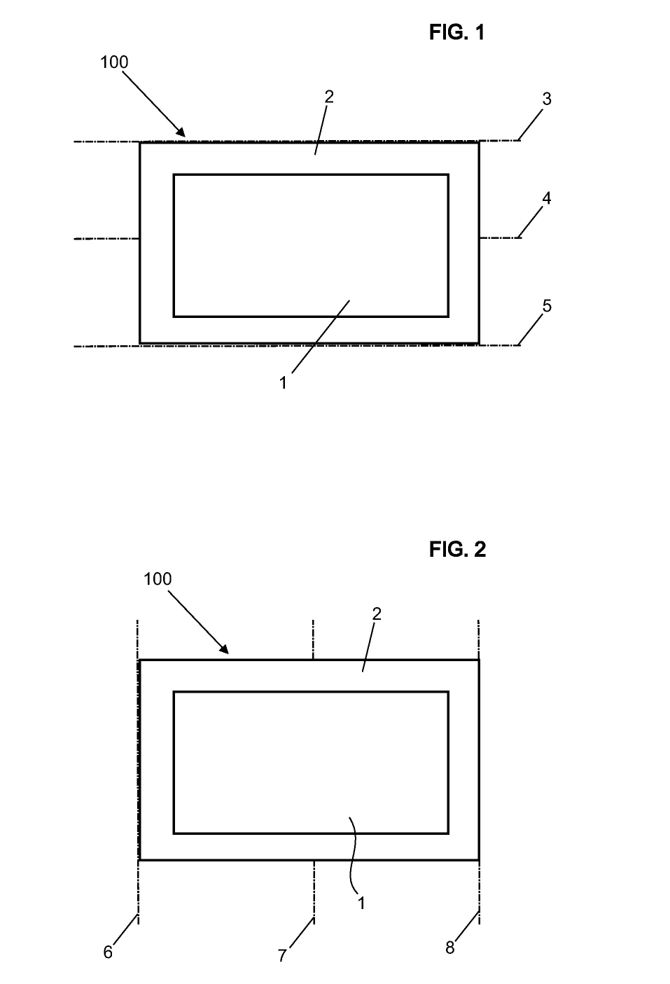

FIG. 1 shows a screen 100. The screen has a screen surface 1, on which, data, text, and image information can be presented. Screen surface 1 is preferably enclosed in a mounting frame 2. Screen 100 preferably exhibits at least one mount, preferably on its back side, or several mounts that are configured in such a way that the screen is twistable about a horizontal axis. A central axis 4 can be arranged in the middle of screen 100. In another embodiment, an upper axis 3 can be arranged in the upper area of screen 100. In a further embodiment, a lower axis 5 can be arranged in the lower area of screen 100.

FIG. 2 shows a screen 100 having a screen surface, 1, on which data, text, or image information can be presented. Screen surface 1 is preferably enclosed in a mounting frame 2. Screen 100 preferably exhibits at least one mount, preferably on its back side, or several mounts that are configured in such a way that the screen is twistable about a vertical axis 7. The vertical axis 7 can be arranged in the middle of screen 100. In another embodiment, a vertical axis 6 is arranged in the left area of screen 100. In a further embodiment, a vertical axis 8 can be arranged in the right area of screen 100.

FIGS. 3a and 3b show a view of a device according to the invention for handling money transactions, 10, such as a pay machine or the like, with a housing 11, and a screen 12. The screen 12 is shown in a folded-in state. Screen 12 is oriented vertically here and the screen surface 1 is essentially flush with the front side of the device's housing.

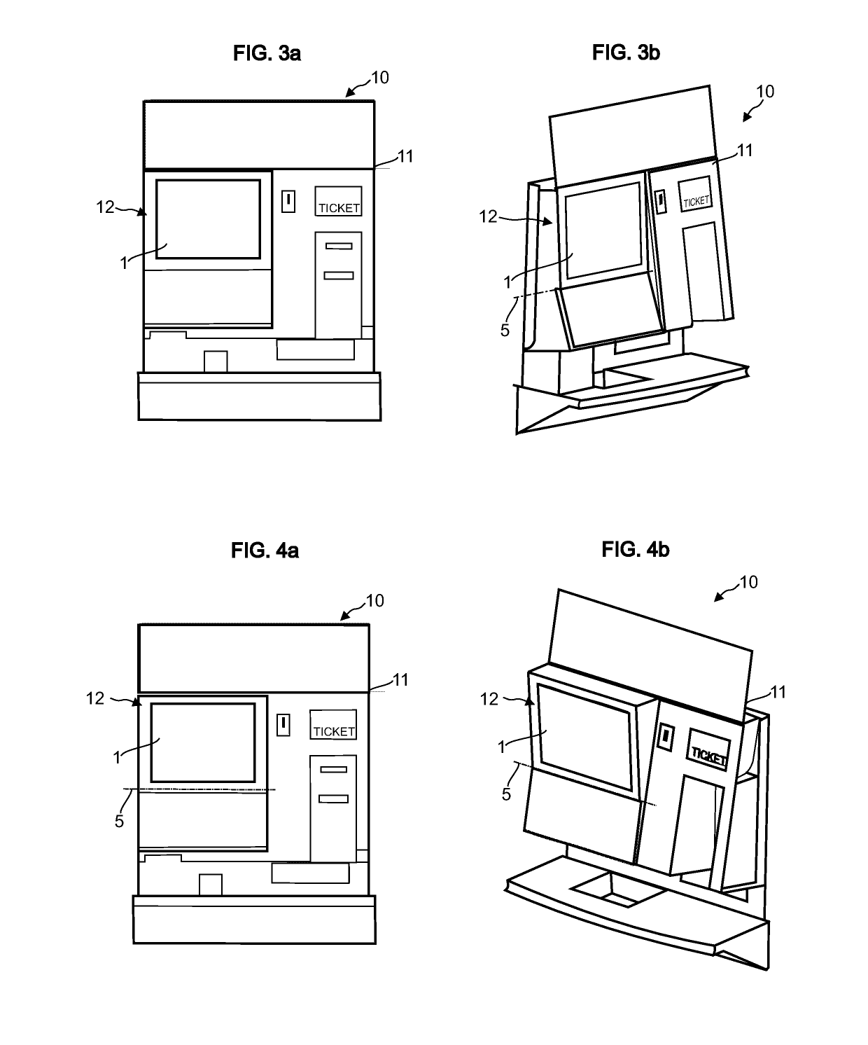

FIGS. 4a and 4b show views of a device according to the invention for handling money transactions 10, such as a pay machine or the like, with a housing, 11, and a screen, 12, which screen, 12, is shown in a swung-out state in FIGS. 4a and 4b. Screen 12 is positioned here about a lower horizontal rotational axis from the vertical to a somewhat oblique, forward-leaning position.

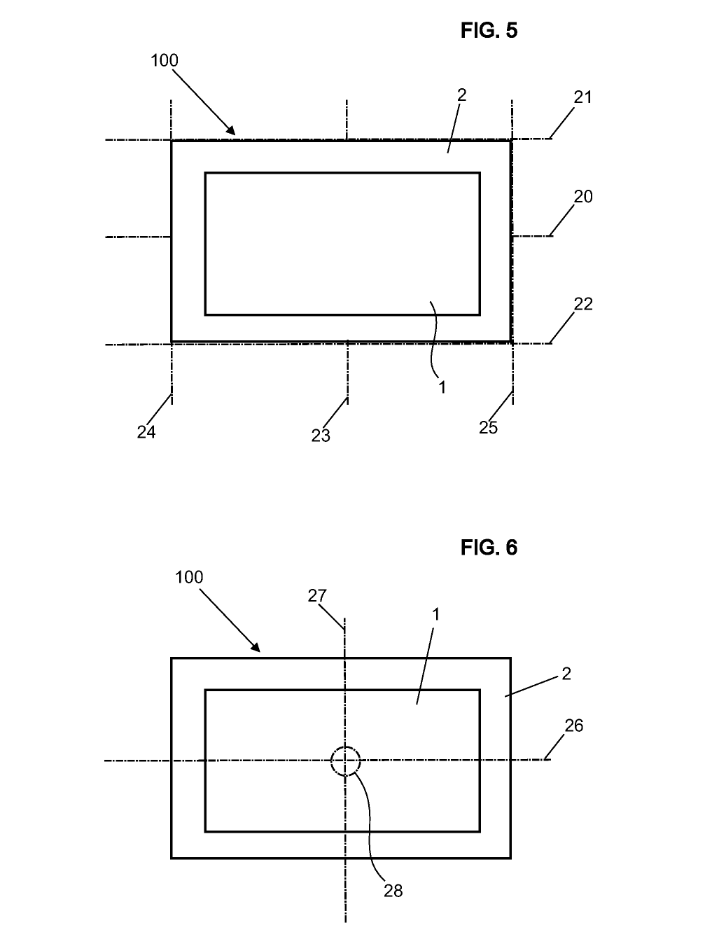

FIG. 5 shows schematically a screen 100 having a screen surface 1. The screen displays data, text, or images, or any combination thereof. Screen surface 1 is preferably enclosed in a mounting frame 2 to hold screen 100. Three horizontal axis's 20, 21 and 22 are shown. Three vertical axis's 23, 24 and 25 are provided. The screen 100 is rotatable about any of these axis's.

Screen 100 preferably includes at least one mount, preferably on its back side, which opposes the surface 1. In one embodiment, several mounts are configured in such a way that the screen is twistable about a horizontal axis. The axis 20 can be arranged in the middle of screen 100.

The axis 21 can be arranged in the upper area of screen 100. In a further embodiment, the axis 22 is arranged in the lower area of screen 100.

Furthermore, at least one mount is configured so that the screen is also twistable about a vertical axis. The axis 23 is arranged in the middle of screen 100. In another embodiment, the axis 24 can be arranged in the left area of screen 100. In a further embodiment, the axis 25 is arranged in the right area of screen 100.

FIG. 6 shows schematically a screen 100 with a screen surface 1. Data, text, or image information can be presented on the screen surface 1. Screen surface 1 is preferably enclosed in a mounting frame 2 to hold the screen 100.

Screen 100 preferably exhibits at least one mount, preferably on its back side, configured in such a way that the screen is twistable about at least one horizontal axis and a vertical axis 27. The mount is constructed advantageous here as ball joint 28, which is advantageously arranged in the middle of the screen. However, ball joint 28 can also be located elsewhere, such as for example on the screen's bottom or top area.

A monitor screen such as an LCD monitor, a touch screen, or other monitor is advantageous for displaying data, such as for instance image, video and/or text data.

The manual adjustment or rotation of the screen is advantageous, but electromotive adjustment can also be provided. Adjustment can occur both manually and electromotively in a preferred embodiment.

As described above, the screen is the screen of a device for handling money transactions, where this device exhibits a housing and a screen enclosed in the housing. The screen 100 is arranged here to be rotatable or tiltable about at least one axis such that tilting the screen can be effected manually or automatically.

In one embodiment of the invention, electromotive operation of the screen is menu driven. A menu can be presented on the screen for this purpose so that what should subsequently be carried out can be selected from the menu. So, for instance, the adjustment can be controlled via touching the screen.

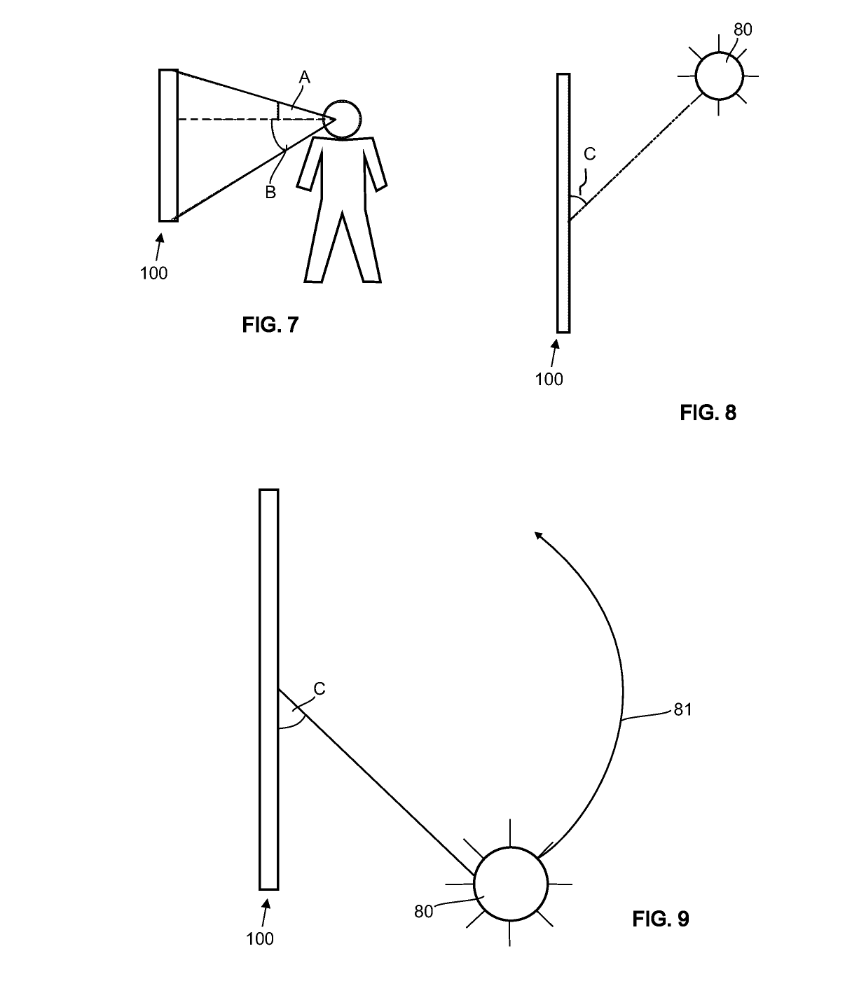

FIG. 7 shows the screen 100 positioned before a viewer and the angles A and B of the viewer's eye's. It is noteworthy that the degree of reflection from solar radiation or other light sources makes it difficult to read information on a screen, and is largely determined by the light source's angle with the screen 100.

FIGS. 8 and 9 show a light source 80, which can be the sun, incident at an angle C on the screen 100. The light source 80 (e.g. the sun) moves along a path 81 in front of the screen 100. The screen 100 is in a fixed position and this movement of the light source 80 causes the angle C to change.

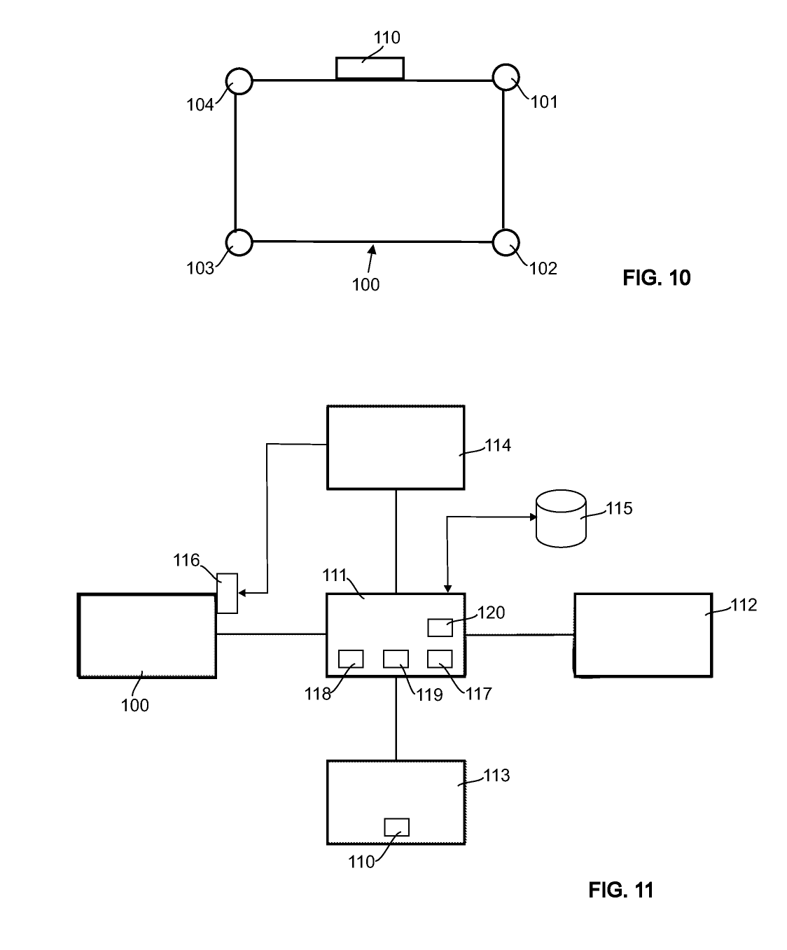

FIG. 10 shows the screen 100 is equipped with light sensors 101, 102, 103, and 104, and a camera 110. The camera 100 is a photographic apparatus that can record still or moving images on an electronic or digital storage medium.

The light sensors 101, 102, 103, and 104, and the camera 110 attaches directly to the device 10 (see FIG. 3a-3b) in an alternate embodiment of the invention. It can be appreciated that positioning of the sensors or camera can be in any position to optimize viewing of the screen 100.

The light sensors 101, 102, 103, and 104 can involve sensors that change their electrical properties during interaction with light. Here this can be for example a photoresistor, photodiode, phototransistor, photocell, photomultiplier, or pyroelectric sensor.

FIG. 11 shows schematically various components of the device 10 in operative communication including a central control unit 111, a sensor module 112, a camera module 113 and the screen 100. The control unit 111 is operatively connected to the sensor module 112, the camera module 113, the screen 100 and the motor controller 114. The control unit 111 cooperates with these various components to optimally adjust orientation of screen 100.

The motor controller 114 includes and controls a drive unit 116, which is coupled to the monitor 100. The central control unit 111 further includes a calibration resource 117, a monitor-angle-detection resource 118, a viewing-angle resource 119 and reflection-angle-determination resource 120. The drive unit 116 includes is connected to electronic-memory resource 115. Initially calibration is conducted using the calibration resource 117.

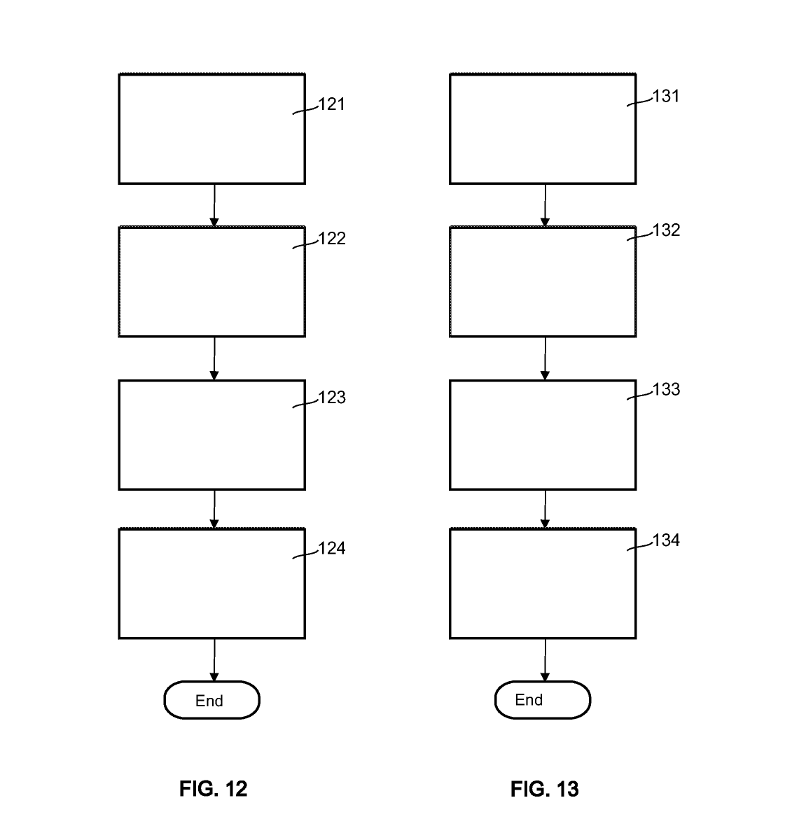

FIG. 12 shows a calibration workflow for use with the hardware shown in FIG. 11, including the sensor module 112 having light sensors 101, 102, 103, and 104. According to processing step 121, the intensity of solar radiation is measured with these during the course of one day, for instance. Maximum or absolute values are not necessarily indicated here, but the relative difference at various time points. The light sensors' measured values can be filtered for ‘outliers’ using various factors (such as buildings' influencing solarization by reflections during the day) according to processing step 122.

An accumulation of differential values per time unit (e g minutes) is made according to processing step 123. The sun's position and the angle of incidence on the screen or the screen surface is explored with the aid of reflection-angle-detection resource 120 as a function of the day and season. The result yielded is the angular position of the sun in relation to the monitor throughout the day. This angle can be electronically stored in storage resource 115 per unit time for later comparison. If necessary, a new calibration will be performed during the course of the year (the sun is different in winter than in summer). Furthermore, in principle, calibration can be run continuously and used again as a reference at certain times.

FIG. 13 describes the progression of changes to the screen's tilt with the aid of monitor-angle-detection resource 118. According to processing step 131, the current time of day determined, for example, using a hardware-based or software-based real-time clock, as well as the stored solarization angle from storage means 115 are called up, or interpolation is done if necessary, to determine a solarization angle corresponding to a non-stored time-angle value.

The optimal view on the screen is not only dependent on the solarization angle, but also on the position of the observer's eye relative to the monitor (see FIG. 7).

According to processing step 132, viewing-angle-determination means 119 detects the eyes (position) of a viewer located in front of monitor 100 with the help of images from camera 113 and a face-detection algorithm. It then calculates the viewing angle A, B. According to processing step 133, optimum angles for the monitor-orientation's horizontal and vertical axes are calculated based on the determined viewing angle and the called-up solarization angle. Monitor-angle-adjustment information so obtained is output to the motor controller. According to processing step 134, drive unit 116 then changes the tilt setting of monitor 100 with the aid of motor controller 114.

1-12. (canceled)

13. A device for handling money transactions, comprising:
a housing for holding a screen;
a sensor module mounted in the housing, the sensor module including light sensors for detecting a light source relative to the screen;
a control unit having a motor;
a joint mounted on the housing; and
a screen mounted on the joint to enable the control unit to move the screen about at least one axis;
wherein in response to detection of a light source, the control unit moves the screen to optimize viewing of the screen.

14. The device as set forth in claim 13, wherein the joint is a ball joint.

15. The device as set forth in claim 13, wherein the sensor module includes a camera.

16. The device as set forth in claim 13, wherein the screen is a touch screen.

17. The device as set forth in claim 13, wherein the screen is a touch screen that displays a menu, the control unit further rotates the screen in response to the menu when the menu of the screen is touched.

18. The device as set forth in claim 13 further comprising a viewing-angle-detection resource to detect a viewing angle of a user; a reflection-angle-detection resource to determine a reflection angle of a light source on the screen; and a monitor-angle-detection resource to determine monitor-angle-adjustment information based on the detected viewing angle and reflection angle.

19. The device as set forth in claim 18, wherein the control unit is operatively connected with the viewing-angle-detection resource and the monitor-angle-detection resource to automatically adjust orientation of the screen.
